(19) United States
(12) Patent Application Publication
(10) Pub. No.: US 2009/0309940 A1
(43) Pub. Date: Dec. 17, 2009

(54) LIQUID STORAGE TANK INCLUDING A PRESSURE REGULATOR

(76) Inventor: Brian G. Price, Pittsford, NY (US)

Correspondence Address: Andrew J. Anderson;Patent Legal Staff, Eastman Kodak Company, 343 State Street, Rochester, NY, 14650-2201, US

(21) Appl. No.: 12/139,533

(22) Filed: Jun. 16, 2008

(51) Int. Cl. B41J 2/175

(52) U.S. Cl. 347/86

(57) ABSTRACT

A liquid tank for storing liquid includes a liquid chamber, a vent, and a pressure regulator. The liquid chamber includes a wall and the vent leads to atmosphere. The pressure regulator includes an enclosure, a first capillary media member, and a second capillary media member. The enclosure extends into the liquid chamber from the wall of the liquid chamber and includes a hole opening into the liquid chamber. The first capillary media member has a first pore size and is located in the enclosure proximate to the vent. The second capillary media member has a second pore size and is located in the enclosure adjacent to the hole. The second pore size is less than the first pore size.

### CROSS REFERENCE TO RELATED APPLICATIONS

Reference is made to commonly assigned U.S. patent application Ser. No. ______ (Docket 94289) filed concurrently herewith entitled “INK TANK FOR INKJET PRINTERS” in the name of Brian G. Price et al, incorporated herein by reference.

### FIELD OF THE INVENTION

The invention relates generally to the field of liquid storage tanks, and in particular to liquid, for example, ink, tanks for inkjet printers.

### BACKGROUND OF THE INVENTION

A critical component of nearly all modern day inkjet printers is an ink tank that delivers ink to the printhead in order to render a printed image. The ink tank prevents leakage of the ink during manufacture, storage, transportation, and the printing operation itself. The ink tank should be capable of containing the ink even under conditions where the pressure within the tank changes due to environmental conditions. For example, pressure variations within an ink tank can occur due to changes in ambient temperature such as when a tank is stored at elevated temperatures in a warehouse or a particular geographic region where high temperatures are encountered. Pressure variations within an ink tank can also occur when the tank is subjected to changes in barometric pressure such as transporting the tank in an airplane or a geographic elevation high above sea level. To this extent, most modern day inkjet ink tanks are designed with some means of pressure regulation to prevent loss of ink during substantial changes in temperature or pressure.

Various designs for regulating the pressure within an inkjet ink tank are known including, bubble generators, reverse bubblers, diaphragms, capillary media and bags. Each of these designs has limitations in the overall system performance of the tank. Ink tanks that use capillary media, such as a foam, fiber or felt, to store ink as a means for pressure regulation have the disadvantage that ink resides directly in the small passages of the capillaries. This is particularly problematic for pigmented inks since pigment particles having sizes greater than about 20 nanometers in diameter are subject to settling phenomena. This is certainly the case for most modern day pigmented inks that have particle diameters in the range of 20 to 500 nanometers.

Pigmented ink can remain in an ink tank for several years from the time of manufacture through storage and use of the tank and this provides ample opportunity for the pigment particles to settle. Ink tank designs where ink is stored in capillary media leads to a situation where pigment particles are restricted in motion within the small passages of the capillary media. This restriction in particle movement is further complicated by the so-called Boycott Effect, wherein the observed sedimentation rate is increased in proportion to the available horizontal surface area within a capillary. For a more detailed description of the Boycott Effect see, Boycott, A. E., Nature, 104: 532, 1920. Both complications lead to an inhomogeneous distribution of pigment particles within the ink carrier fluid that can manifest itself as defective images during the printing process. For example, the non-homogeneous pigmented ink can result in images having a textured appearance reminiscent of a wood grain appearance if the pigmented ink is stored in the capillary media within an ink tank. This leads to a limitation in the selection of the pigment particle size since larger particles, which can be beneficial to providing higher optical density in printed regions, are disadvantaged from a settling and homogeneity standpoint when stored in a capillary media.

A second limitation for ink tanks using capillary media is the wasted ink associated with the capillary media. Ink tank designs where capillary media is used to store ink can result in a finite amount of ink that remains trapped in the capillary media at the end of the useful life of the tank. Ink that remains trapped is effectively wasted ink as it is not available for transport to the printhead and ultimately for printing of an image. It would be desirable to minimize the amount of ink trapped in the capillary media of an ink tank.

A third limitation for ink tanks used in modern day inkjet printers is a changing pressure versus ink extraction volume profile within the tank during the useful life of the tank as ink is consumed during the printing operation. This changing pressure versus extraction volume profile occurs because the pressure within the ink tank changes as the amount of ink that is stored within the capillary media changes. It is desirable that an ink tank maintains enough negative pressure to prevent ink from weeping out of the printhead nozzles during periods where the printhead is idle. Excessively high negative pressure in the ink tank can adversely affect the jetting performance of the printhead. Significant changes in backpressure can also negatively affect the ability of the printhead to maintain a constant drop volume over the lifetime of the ink tank. Variations in drop volume can lead to non-uniform image appearance in the printed image. It would be therefore be desirable to have an ink tank design that is capable of maintaining a substantially constant pressure throughout consumption of the ink in the printer.

Designs are known for ink tanks having a secondary ink storage chamber located within the main ink tank where the secondary ink chamber includes capillary media, such as U.S. Pat. Nos. 5,682,189, 5,703,633, 6,880,921, 7,252,378, and 7,290,871. Designs of this type suffer from the limitation that pigmented ink stored in the secondary ink chamber would be subject to settling, non-homogeneity and a non-constant pressure versus extraction volume as described above. Designs for inkjet tanks are also known where two capillary media of different porosities are present in a main chamber where ink is stored, such as U.S. Pat. Nos. 5,233,369, 5,453,771, 6,186,621, 6,431,672, and PCT International Publication Number WO 2007/138624. However, the ink tanks in these designs utilize the capillary media in the main storage portion for the ink and are also subject to the limitations discussed above for pigmented inks.

The limitations in the design of ink tanks for inkjet printers where capillary media is used indicates the need for an ink tank that would be capable of storing ink, even during conditions where pressure excursions can exist, where ink is not intended to be stored within the capillary media at normal operating pressures. There is also a need for an ink tank that is capable of providing a constant pressure versus extraction volume throughout the useful life of the tank as ink is removed during printing. A need also exists for an ink tank, and in particular a tank for pigmented ink, which can maximize the amount of ink available to the printhead for printing of images from an inkjet printer.

### SUMMARY OF THE INVENTION

The present invention is directed to overcoming one or more of the problems set forth above. Briefly summarized, according to one aspect of the present invention, liquid tank includes a liquid storage chamber and a pressure regulator that forms an enclosure. The pressure regulator includes a vent to atmosphere for allowing air to enter the liquid storage tank. The enclosure includes two capillary media members of different pore sizes and at least one hole designed such that the enclosure inhibits storage of liquid during normal operating pressures. The capillary media member having a larger pore size is located within the enclosure proximate to the vent. The capillary media member having a smaller pore size is located within the enclosure adjacent to the hole.

According to another aspect of the invention, the liquid storage tank having the enclosed pressure regulator arrangement exhibits a substantially constant pressure versus extraction volume profile over the useful life of the storage tank.

According to another aspect of the invention, the liquid storage tank contains a pigmented ink and a supply port for delivering the pigmented ink to a printhead of an inkjet printer.

According to another aspect of the invention, a liquid tank includes a pressure regulator structure including a capillary media member configured to provide the liquid tank with a linear pressure versus volume of liquid extraction profile.

According to another aspect of the invention, a method of supplying liquid to a printhead includes providing a liquid tank including: a liquid chamber including a liquid, the liquid chamber including a wall; a vent that leads to atmosphere; and a pressure regulator including: an enclosure extending into the liquid chamber from the wall of the liquid chamber, the enclosure including a hole opening into the liquid chamber; a first capillary media member having a first pore size, the first capillary media member being located in the enclosure proximate to the vent; and a second capillary media member having a second pore size, the second capillary media member being located in the enclosure adjacent to the hole, the second pore size being less than the first pore size; and causing the liquid to flow from the liquid chamber of the liquid tank to a printhead.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a cross-sectional view of a prior art liquid tank having two capillary medias contained therein;

FIG. 2 is a cross-sectional view of a prior art liquid tank having a secondary ink storage chamber filled with capillary media;

FIG. 3 is an exemplary embodiment of a liquid tank of the present invention;

FIG. 4 is a projection view through the bottom wall of an exemplary embodiment of a liquid tank of the present invention;

FIG. 5 is a close-up perspective view of an exemplary embodiment of a pressure regulator of the present invention; and

FIG. 6 is a plot showing the pressure versus extraction volume profiles for two prior art ink tanks and one exemplary embodiment of an ink tank of the present invention.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

To facilitate understanding, identical reference numerals have been used, where possible, to designate identical elements that are common to the figures.

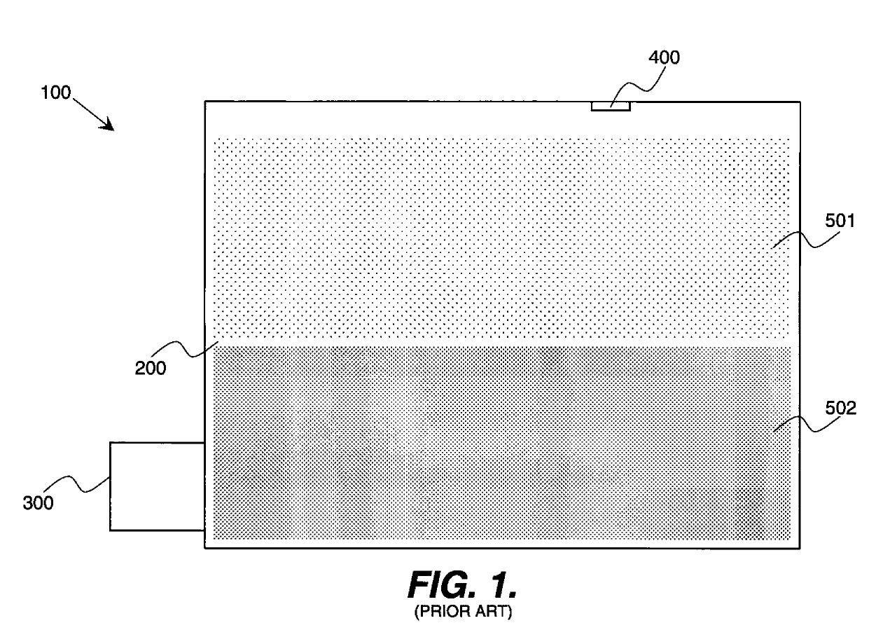

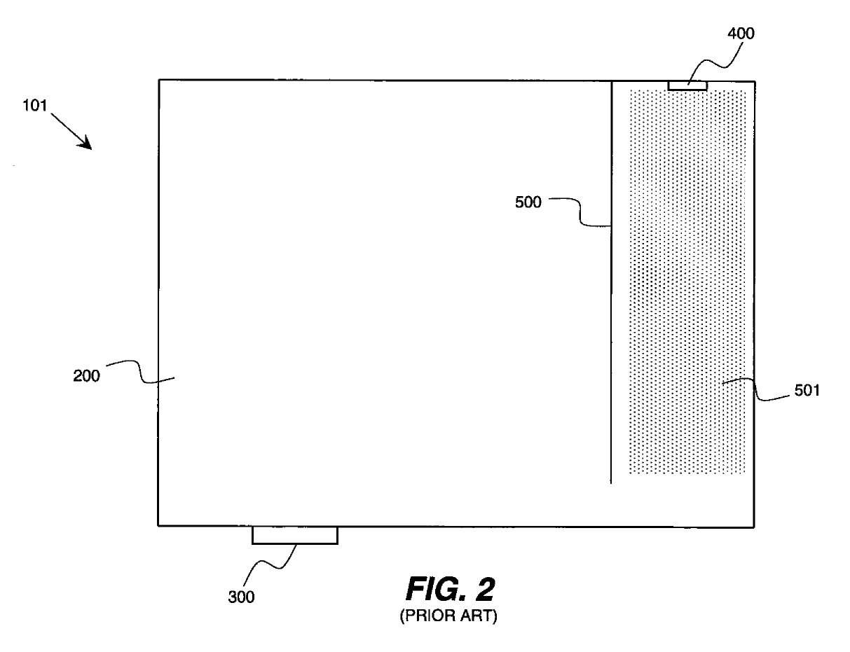

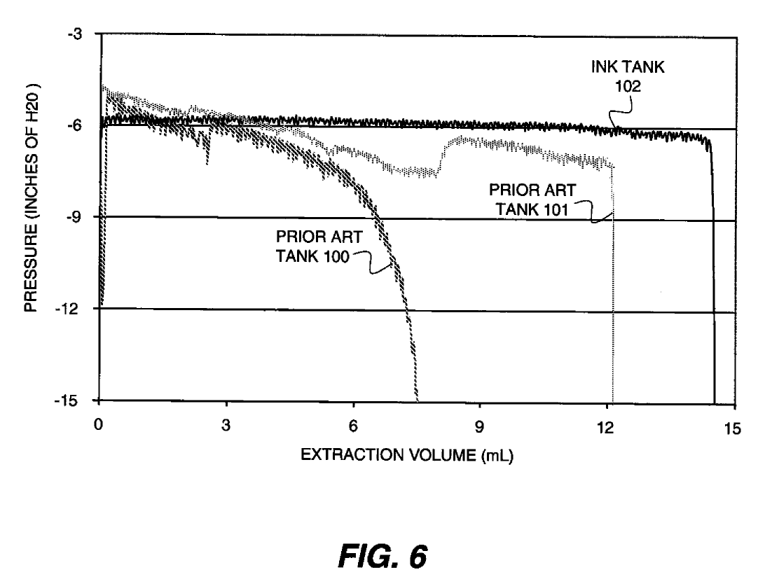

Prior art liquid tanks known in the art of inkjet printing are exemplified by FIGS. 1 and 2. FIG. 1 exemplifies a prior art inkjet ink tank 100 having a vent 400 to atmosphere at the top of the ink tank and a plurality of capillary media members 501 and 502 positioned within liquid chamber 200 used for storing ink. Ink stored within the liquid chamber 200 of FIG. 1 is supplied to the printhead through a supply port 300 that directly interfaces with the second capillary media member 502. In this arrangement, a pigmented ink would be directly stored in the pores of the capillary media members 501 and 502 for the entire useful lifetime of the ink tank and would experience the limitations discussed above. In particular, the prior art ink tank exemplified in FIG. 1 would experience a non-constant pressure versus ink volume extraction profile exemplified in FIG. 6 and discussed in further detail below. In addition, the prior art ink tank 100 of FIG. 1 would be prone to printing defects caused by storage of pigmented ink in the small pores of capillary media

FIG. 2 exemplifies a prior art ink tank 101 having a vent 400 to atmosphere at the top wall of the ink tank, a liquid chamber 200 and a secondary ink storage compartment 500 that includes a capillary media member 501. The secondary ink storage compartment 500 of prior art tank 101 is open to the liquid chamber 200 to allow open fluid communication between the two ink storage compartments. The secondary ink storage compartment 500 of ink tank 101 lacks the feature of a plurality of capillary media members 501 and 502 that differ in their pore size and the feature of an enclosure forming a pressure regulator. This provides less than optimal leak protection through the vent 400 in the event of a pressure or temperature excursion as ink can readily climb the entire distance of the single capillary media member 501. The prior art ink tank 101 suffers from the limitation that pigmented ink resides in the capillary media 501 contained within the secondary storage compartment 500. Ink tank 101 also provides a less than constant pressure versus extraction volume profile. Ink tank design 101 also has the drawback that ink will experience a hysteresis cycle between the liquid chamber 200 and the secondary ink storage compartment 500 each time printing is started and stopped.

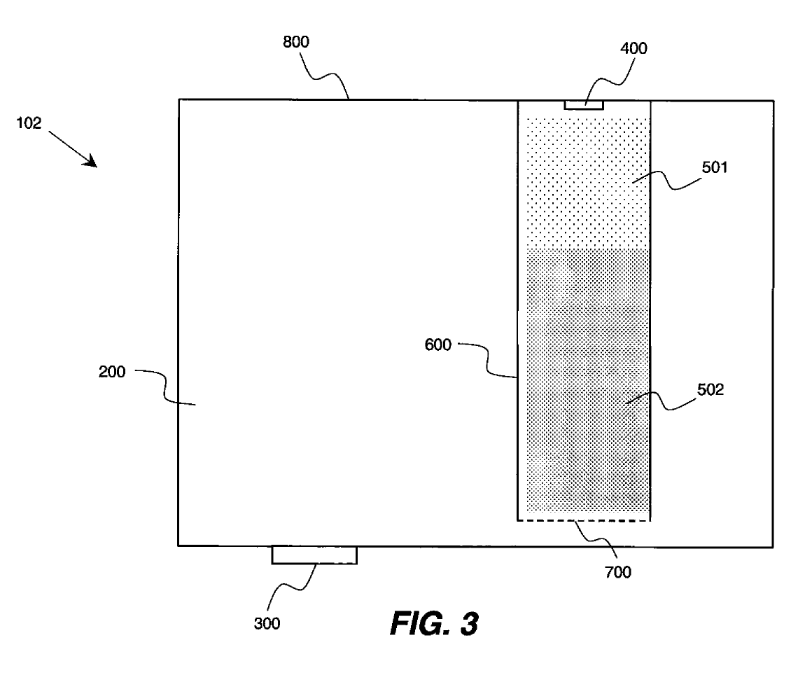

FIG. 3 exemplifies an embodiment of the liquid tank 102 of the present invention. The liquid tank 102 includes liquid chamber 200 including a wall that is ideally sealed to the atmosphere. Liquid is supplied from the liquid chamber 200 through a supply port 300 that is located on a lower portion of the liquid chamber and which is ideally located on the bottom wall of the liquid tank 102. The liquid tank 102 includes a pressure regulator 600 that excludes ink during normal operating conditions, but which also acts as a reservoir to contain liquid during significant pressure excursions.

The pressure regulator 600 forms an enclosure that extends from a wall of the liquid chamber 200 and includes a plurality of capillary media members 501 and 502. The pressure regulator 600 can have any shape that does not impede the function of excluding liquid from the liquid chamber 200 during normal operating pressures of the liquid tank 102 while providing pressure regulation for the liquid tank. The pressure regulator 600 forms an enclosure that can be in the form of a tube, cylinder, or other hollow geometric shape and can extend downward from a top wall of the liquid chamber 200 unsupported by the sidewalls of the liquid tank 102. Alternatively, one or more sidewalls of the liquid tank 102 can form a part of the enclosure that defines the pressure regulator 600. In one exemplary embodiment (not shown), an upper portion of the pressure regulator 600 is wider at its periphery than a lower portion of the pressure regulator. The upper portion of the pressure regulator 600 can taper at an angle to a lower portion of the pressure regulator. Such geometries can allow for design of a liquid tank 102 that can accommodate different sized and shaped capillary media members and can provide extra protection against liquid leakage during substantial pressure excursions.

The pressure regulator 600 includes a first capillary media member 501 and a second capillary media member 502. The first capillary media member 501 is designed such that it has a larger pore size (lower capillarity) than the second capillary media member 502 and is primarily responsible for containment of liquid in the event of an overflow past the second capillary media member 502. The second capillary media member 502 is designed such that it has a smaller pore size (higher capillarity) than the first capillary media member 501. The second capillary media member 502 does not need to be of any particular height, but only needs to be the final barrier for air to the liquid, so that it is the pressure-determining air-liquid-media interface.

Any of the known capillary media types can be used for the first and second capillary media members 501 and 502 as long as they obey the hierarchy of capillarity as defined herein. Suitable materials for capillary media members 501 and 502 of the present invention include; foams, felts or fibers. Foams useful as capillary media members can be made from synthetic materials such as, for example; polyurethanes, polyesters, polystyrenes, polyvinylalcohol, polyethers, neoprene, and polyolefins. Fibers or felts useful as capillary media members can be made from synthetic materials such as, for example; cellulosics, polyurethanes, polyesters, polyamides, polyacrylates, polyolefins, such as polyethylene, polypropylene, or polybutylene, polyacrylonitrile, or copolymers thereof. Additional examples of capillary media member materials are exemplified in PCT International Publication Number WO 2007/138624, which is incorporated herein in its entirety by reference.

The capillary media members 501 and 502 are located within the pressure regulator 600 such that the first capillary media member 501 (larger pore size) is closer to the wall of the liquid chamber 200 from which the pressure regulator extends than the second capillary media 502 (smaller pore size). In this arrangement the first capillary media 501 is closer to the vent 400 than the second capillary media 501. This advantages the pressure regulation and overflow features of the present design by limiting the height that the ink can travel up the capillary media members during pressure excursions. In one embodiment the capillary media members 501 and 502 are two separate pieces that contact each other in the pressure regulator 600. Alternatively, capillary media members 501 and 502 can be integrally formed or joined (for example, fused) together to form a single piece. The second capillary media member 502 is located in the enclosure that forms the pressure regulator 600 such that it is adjacent to a hole 700 in the enclosure. Ideally the second capillary media member 502 is in contact with a hole 700 in the enclosure.

The pressure regulator 600 is vented to the atmosphere through a vent 400. As liquid is consumed from the liquid chamber 200 through the supply port 300, air can enter the liquid tank through the vent 400 and pressure regulator 600 to equalize the pressure within the liquid tank 102. The vent 400 is located in a position on the liquid tank 102 such that air can only flow into the tank through the pressure regulator 600. The vent opening 400 can be covered on the inside of the liquid tank 102 by a semi-permeable membrane. The vent 400 can be covered from the outside of the liquid tank 102 by a label that is adhered to a wall 800 of the liquid tank 102 by a thermally cured adhesive or a pressure sensitive adhesive in order to aid in keeping liquid from migrating out of the liquid tank. The vent can be connected to a channel in the wall 800 of the liquid tank 102 that is capable of holding liquid in the event of an extreme barometric or temperature excursion. The first capillary media member 501 is located within the enclosure of the pressure regulator 600 proximate to the vent 400 and an air gap can exist between the first capillary media member and the vent.

A portion of the enclosure forming the pressure regulator 600 includes a hole 700 that is small enough that it inhibits liquid contained in the liquid chamber 200 from entering the pressure regulator during normal operating pressures. The pressure regulator 600 can be made from a single continuous material where the enclosure is formed during manufacturing (e.g. by injection molding) of the liquid tank 102. In this arrangement, the hole 700 can be formed during the manufacture of the pressure regulator 600, or can be formed as a separate step, such as a drilling or machining operation after formation of the enclosure. Optionally, the hole 700 can complete the enclosure by attaching a separate piece to an open portion of the pressure regulator 600. A separate filter, frit, screen or surface with a preformed hole 700 can be attached by a welding, threading or adhesive operation to the pressure regulator 600 to complete the enclosure. In such a configuration, the capillary media members 501 and 502 can be loaded into the bottom of the pressure regulator during manufacturing of the liquid tank 102.

The hole 700 of the pressure regulator 600 can be sized to facilitate the passage of air from the vent hole 400 to the liquid chamber 200 as liquid is consumed from the supply port 300 while inhibiting the passage of liquid from the liquid chamber into the pressure regulator during normal operating pressures and temperatures. In one exemplary embodiment the cross-sectional area of the hole 700 is less than or equal to about 2 square millimeters. In another exemplary embodiment the cross-sectional area of the hole 700 less than about 2 square millimeters, but greater than or equal to about 0.05 square millimeters. The hole 700 can be a plurality of holes in the enclosure. In one exemplary embodiment, the plurality of holes are present in a continuous molded enclosure. In another embodiment, the plurality of holes are a screen that is attached to the enclosure. It is possible to have one hole having a cross-sectional area of about 1-2 square millimeters, or several smaller holes, or any combination thereof. The hole 700 can be any geometric shape including circular, square, irregular or any other shape that facilitates ease of manufacturing of the liquid tank 102. In one exemplary embodiment the total cross-sectional area of the plurality of holes 700 is greater than 0.5 square millimeters and less than 10 square millimeters.

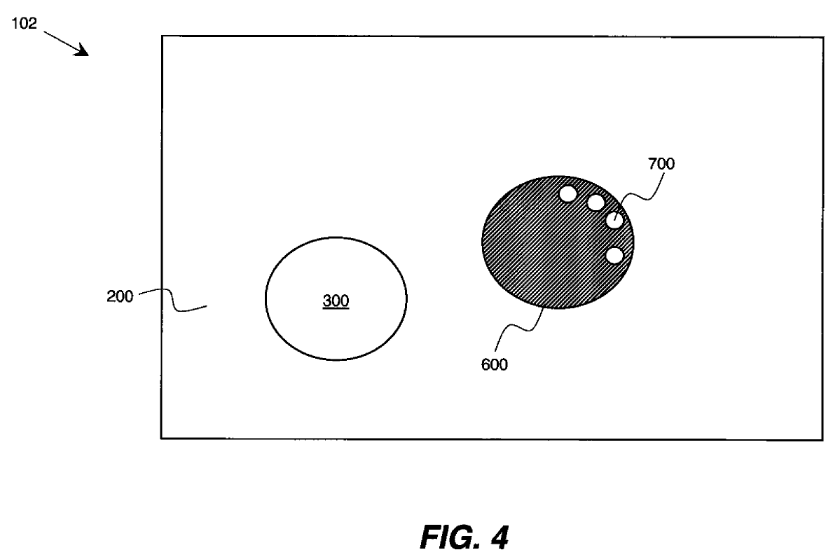

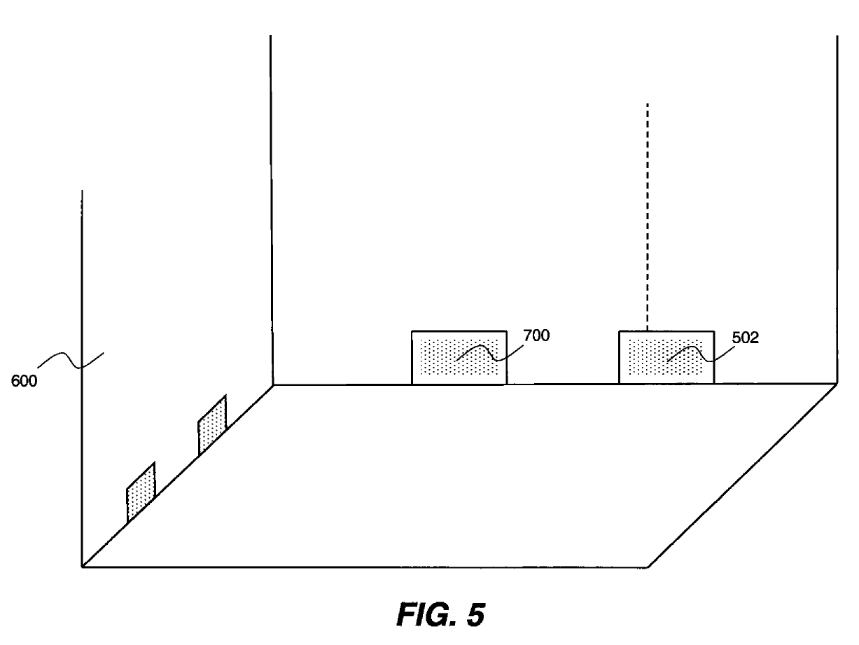

The hole 700 can be formed on a bottom surface of the enclosure, as exemplified in FIG. 4, or can be formed in a portion of a wall forming the enclosure as exemplified in FIG. 5. When the hole 700 is a plurality of holes, they can be arranged in any pattern on the enclosure including a random arrangement or in a specific pattern. In one embodiment, the holes are arranged on a portion of the enclosure that faces away from the supply port 300 as shown in FIG. 4. This has the advantage of directing air bubbles that enter the liquid chamber 200 from the vent 400 and pressure regulator 600 away from the supply port 300. In another embodiment, the plurality of holes 700 are spaced substantially equidistant from one another around the perimeter of the enclosure of the pressure regulator 600. This has the advantage of distributing the available contact area between the second capillary media member 502 and the plurality of holes 700 more uniformly.

Liquid storage tanks of the present invention have the novel feature that they provide a relatively constant pressure versus extraction volume profile when compared to liquid storage tanks known in the art. This is shown in FIG. 6. In order to measure the pressure versus extraction volume profile that is characteristic of an ink tank (or each ink tank measured), the tank is first mounted in a holding fixture maintaining the same orientation in which it would be found when installed in a printer. A means of fluid communication that mimics the fluid delivery system of the printer is then established. The fluid communication means includes a pressure sensor positioned in the fluid path at a height that matches the height of the nozzle plate of the printhead as if the ink tank had been connected to a printhead of a printer. Finally, fluid is withdrawn from the tank at a constant rate, for example, using a peristaltic pump operating at 4 mL per minute, and the pressure is measured throughout the extraction process. For measuring purposes, each ink tank is initially filled with the same amount of liquid. In FIG. 6, this is approximately 15 mL

The pressure versus extraction volume profiles in FIG. 6 can exhibit an abrupt change in the pressure versus ink volume extraction at the initial stage of ink extraction. It is believed that this initial abrupt change commonly occurs although the magnitude of the abrupt change may vary depending on the design of the ink tank, manufacturing variability within a particular tank design and the environmental conditions in which the tank operates.

It is believed that the abrupt change in the pressure versus ink volume extraction at the initial stage of ink extraction is an artifact of the measurement technique and is explained by the following. Upon initial installation of an ink tank into a printer, fluid communication between the printhead and ink tank is not necessarily established, and thus the measured pressure does not represent the operating pressure of the ink tank. During priming, as flow from the ink tank is established, the pressure inside the printhead is observed to change abruptly to the operating pressure of the ink tank, after which point it then follows the pressure-volume profile determined by the operating principle of the tank. After reaching the operating pressure of the ink tank, the volumetric entry rate of air into the tank matches the volumetric extraction rate of ink from the tank. This is typically referred to as steady state operation of the ink tank.

Each of the profiles shown in FIG. 6 exhibits a high frequency pressure oscillation having an amplitude that is typically less than 0.5 inch of water over the range of extraction volumes. These high frequency oscillations are an experimental artifact introduced by the peristaltic pump. In FIG. 6, these high frequency oscillations are not of interest when measuring the overall slope of the profiles.

FIG. 6 shows a non-linear pressure versus extraction volume (the pressure is measured in inches of water where zero represents atmospheric pressure, and the extraction volume is measured in milliliters of liquid) profile for prior art ink tanks having designs corresponding to liquid tanks 100 and 101. For example, the profile in FIG. 6 corresponding to pressure versus extraction volume for liquid tank 100 shows that the average pressure changes from around −6 inches of water to around −15 inches of water over the range of extraction volumes from around 1 mL to 7.5 mL. Note that the total amount of liquid extracted from ink tank 100 is approximately only 50% of the liquid amount initially loaded into the tank. A profile is shown for liquid tank 101 over the range of extraction volumes from around 1 mL to 12 mL. Note that the total amount of liquid extracted from ink tank 101 is approximately only 80% of the liquid amount initially loaded into the tank. The average pressure for liquid tank 101 changes in a non-linear fashion from around −4 inches of water to around −8 inches of water at which point a sharp drop in pressure occurs as the entire extractable ink volume is removed.

These profiles represent the average change in pressure during the useful lifetime of the ink tank. This non-linear pressure versus extraction volume profile for liquid tanks 100 and 101 is directly related to the storage of fluid in the pores of the capillary media. As liquid is removed from the storage tank design of ink tank 100 or 101, the pressure drops in a non-linear fashion as ink is pulled from the capillary media 501 or 502. This profile continues until the extractable liquid is removed from the capillary media. The low liquid removal efficiency rates (approximately 50% and approximately 80%) are also directly related to the storage of fluid in the pores of the capillary media.

FIG. 6 shows a linear pressure versus extraction volume profile throughout the entire useful lifetime of liquid storage tank 102 of the present invention. The profile shown in FIG. 6 for liquid storage tank 102 exhibits an average change of less than 1 inch of water over the useful lifetime of the ink tank over a range of less than 1 mL to approximately 15 mL of extraction volume. Note that the total amount of liquid extracted from ink tank 102 is approximately 100% of the liquid amount initially loaded into the tank. Generally, ink tank 102 exhibits extraction efficiencies greater than 90%. It has been determined experimentally that liquid extraction efficiency for ink tank 102 is independent of extraction rate. In contrast, it has been determined that ink tanks 100 and 101 have extraction efficiencies that are strongly dependent upon extraction rates in that extraction efficiency decreases as extraction rate increases.

The design of storage tanks exemplified by storage tank 102 inhibit liquid from entering the pressure regulator so that the pressure within the tank remains relatively constant even when liquid removal is periodically stopped and restarted. As is evident in FIG. 6, the pressure regulator 600 in liquid storage tank 102 is designed such that the slope of the pressure versus extraction volume profile is less than about 1 inch of water per 10 ml of extraction volume (i.e. the average slope is less than about 0.1 inch of water per mL of extraction volume). More specifically, the slope of the pressure versus extraction volume for ink tank 102 in FIG. 6 is about 0.02 inch of water per mL of extraction volume.

The average slope is determined at a starting extraction volume just beyond the initial sharp drop in the pressure versus extraction volume profile described above (at the point where the operating pressure of the ink tank is established) and an ending extraction volume of a majority of the ink stored in the tank. The ending extraction volume is dependent on the storage capacity or size of the ink tank. Typically, the slope is determined at an ending extraction volume that is at least 50% of the total ink volume, preferably at least 75% of the total ink volume, and more preferably over the entire volume of useable ink stored in the tank. For example, the average slope of the pressure versus extraction volume shown in FIG. 6 is measured for ink tank 102 between about 0.3 milliliters and about 14 milliliters of extraction volume.

The invention has been described with reference to a preferred embodiment. However, it will be appreciated that variations and modifications can be effected by a person of ordinary skill in the art without departing from the scope of the invention.

### PARTS LIST

100 Prior Art Ink Tank
101 Prior Art Ink Tank
102 Liquid Tank
200 Liquid Chamber
300 Port
400 Vent
500 Secondary Ink Storage Compartment
501 First Capillary Media Member
502 Second Capillary Media Member
600 Pressure Regulator
700 Hole
800 Wall

1. A liquid tank comprising:
a liquid chamber including a wall;
a vent that leads to atmosphere; and
a pressure regulator including:
an enclosure extending into the liquid chamber from the wall of the liquid chamber, the enclosure including a hole opening into the liquid chamber;
a first capillary media member having a first pore size, the first capillary media member being located in the enclosure proximate to the vent;
a second capillary media member having a second pore size, the second capillary media member being located in the enclosure adjacent to the hole, the second pore size being less than the first pore size.

2. The tank of claim 1, wherein the liquid chamber includes free flowing liquid.

3. The tank of claim 2, wherein the free flowing liquid is a pigmented ink.

4. The tank of claim 1, the liquid chamber including a port, wherein the hole is disposed on a portion of the enclosure that faces away from the port.

5. The tank of claim 1, wherein the hole is sized to facilitate the passage of air from the vent to the liquid chamber while inhibiting liquid passage from the liquid chamber to the pressure regulator.

6. The tank of claim 5, wherein the cross-sectional area of the hole is less than or equal to 2 square millimeters.

7. The tank of claim 6, wherein the cross-sectional area of the hole is greater than or equal to 0.05 square millimeters.

8. The tank of claim 5, wherein the hole includes a plurality of holes, the plurality of holes having a total cross-sectional area that is greater than 0.5 square millimeters and less than 10 square millimeters.

9. The tank of claim 5, wherein the hole includes a screen.

10. The tank of claim 1, wherein the first capillary media member and the second capillary media member contact one another.

11. The tank of claim 1, wherein the second capillary media member is in contact with the hole.

12. The tank of claim 1, wherein the first capillary media member and the second capillary media member are a single piece.

13. A liquid tank comprising:
a pressure regulator structure including a capillary media member configured to provide the liquid tank with a linear pressure versus volume of liquid extraction profile.

14. The tank of claim 13, wherein the linear pressure versus volume of liquid extraction profile has an average slope of less than 0.1 inch of water per milliliter of extraction volume.

15. The tank of claim 14, wherein the slope is measured at a steady state operating pressure of the liquid tank.

16. The tank of claim 13, the liquid tank including a liquid extraction efficiency, wherein independent of extraction rate, the liquid extraction efficiency is greater than 90%.

17. A method of supplying liquid to a printhead comprising:
providing a liquid tank comprising:
a liquid chamber including a liquid, the liquid chamber including a wall;
a vent that leads to atmosphere; and
a pressure regulator including:
an enclosure extending into the liquid chamber from the wall of the liquid chamber, the enclosure including a hole opening into the liquid chamber;
a first capillary media member having a first pore size, the first capillary media member being located in the enclosure proximate to the vent;
a second capillary media member having a second pore size, the second capillary media member being located in the enclosure adjacent to the hole, the second pore size being less than the first pore size; and
causing the liquid to flow from the liquid chamber of the liquid tank to a printhead.
